(19) United States
(12) Patent Application Publication
(10) Pub. No.: US 2012/0109817 A1
(43) Pub. Date: May 3, 2012

(54) Product and Method of Providing First Class Customer Service or Product Support

(76) Inventors: Robert Villalobos, Laguna Beach, CA (US); Linda Shackelford, North Highlands, CA (US)

(21) Appl. No.: 13/208,243

(22) Filed: Aug. 11, 2011

Related U.S. Application Data
(60) Provisional application No. 61/407,592, filed on Oct. 28, 2010.

(51) Int. Cl. G06Q 40/00

(52) U.S. Cl. 705/39

(57) ABSTRACT

Disclosed is productized customer service and related methods of use.

### CROSS-REFERENCE TO RELATED APPLICATIONS

This application claims the benefit of priority to U.S. Provisional Application No. 61/407,592 (filed Oct. 28, 2010) entitled “The Charging for Customer Service Product,” and said provisional patent application is hereby incorporated by reference in its entirety.

### STATEMENT REGARDING FEDERALLY SPONSORED RESEARCH OR DEVELOPMENT

Not Applicable.

### BACKGROUND OF THE INVENTION

1. Field of Invention

The present disclosure generally relates to the field of customer service or support, methods, and mechanisms of delivering the same (including by machine readable software or programming code). More particularly, the present disclosure relates to productized customer service (e.g., customer service as a product) and/or methods of improving, commercializing, and adapting enhanced customer service to a variety of existing online and other services.

2. Background.

Customer service or support (hereinafter “customer service”) may be the provision of services by an entity to its customers or purchasers of its goods or services. Frequently, customer service is designed to enhance customer satisfaction, with respect to a good or service. In some instances, customer service may involve: tutorials for maximizing the potential or accomplishing full enjoyment of a good or service; troubleshooting and/or resolving problems with a good or service; and resolving concerns of a customer with respect to a good or service. Good customer service, known herein as “first class” customer service, is unautomated customer service that is readily available to, and readily accessible by, a customer (e.g., a live customer service agent with a direct and available line of communication with a customer). Especially since the inception of the internet, there are many companies who rely exclusively on online “help” features to provide assistance to customers. This can be annoying and unsatisfactory to people who desire to speak with another conversant human.

Customer service, first class customer service in particular, may represent an expense of an entity that sells goods or services to customers. Frequently, the expenses associated with providing customer services are recouped by the entity via building said expenses into the price of the goods or services. Although satisfactory in some instances, building customer service costs into the price of a good or service has not been entirely satisfactory whenever goods or services are provided to a customer in exchange for a contingent payment because customer service costs are incurred by the entity without a guarantee of the expenses being recouped. Such unguaranteed payment for a good or service typically leads to non-existent or lacking (i.e., below first-class) customer service. For example, customer service may be economically provided to the purchaser of a lawnmower via building customer service costs into the sale price of the lawnmower because purchase payment is guaranteed by the purchaser. By contrast, Google® cannot economically provide first class customer service to a recipient of its AdSense® collection services (an advertisement revenue collection service for a website owner that provides pay-per-click advertisements) since the associated collection fee represents a percentage of advertisement revenues that may be nominal or nonexistent. Fees are only generated if web-browsers click on a link that results in an account debit. Accordingly, there is a need for a product or method of providing customer service, first class customer service in particular, that permits entities to provide first class customer service to purchasers of goods or services, even in instances where contingent fees are the source of revenue to the website.

Building customer service costs into the price of a good or service has additionally not been entirely satisfactory whenever goods or services are provided for free to a user in exchange for revenues (e.g., advertisement revenues) derived from a community of users. Most frequently, built-in customer service costs are unsatisfactory in the above identified circumstance because per-user revenues may not economically support individual user customer services. For example, Facebook® provides free social networking services to a large community of users in exchange for advertising revenues derived from the community, but first class customer service cannot economically be provided to said users on an individual basis since the advertising revenues per user are insufficient to justify individual customer service; instead, Facebook® provides discussion boards or communal product support (discussion boards and/or communal product support are inadequate since such services are typically slow and often non-responsive to prayers of service from the users). Accordingly, there is a need for a productized customer service, first class customer service in particular, and related methods which permit entities to provide first class customer service to individual users of goods or services paid for with revenues derived from a community of users.

Yet still another unsatisfactory aspect of built in customer services is that such are an expense rather than a revenue generating product. That is to say, the costs of customer services have been regarded as an expense in need of minimization so that entities providing customer service have had an incentive to provide as little customer service as possible (e.g., below first class). Accordingly, there is a need for productized customer service or methods of providing customer service, first class customer service in particular, that incentivizes entities to provide as much customer service as possible (e.g., allows entities to profit from providing customer service).

### SUMMARY OF THE INVENTION

In view of the foregoing, it is an object of this disclosure to enable productized customer service (including first class customer service) or methods of providing customer service (including first class customer service) to purchasers of goods or services with contingent fees or to individual users of goods or services purchased with revenues derived from a community of users.

To meet this objective, disclosed may be productized customer service or a method of providing customer service, including the steps of: providing an option to a consumer of a good or service to purchase the customer service; collecting a fee from the consumer whenever said option is exercised; providing the consumer with a line of communication (e.g., instant text messaging, phone line, email and the like) with a customer service agent whenever said fee is collected; and directing the agent to communicate with the consumer via said line of communication.

To further meet this objective, disclosed is a method of providing customer service, including first class customer service, the method comprising the steps of: providing an option for a consumer of a good or service to purchase live interaction with the staff member of the customer service department; providing the user with a direct phone number or an access code to enable communication with the staff member of the customer service department; collecting a fee from the user for said provision of said option; and providing live communication between the user and the staff member of the customer service department.

Yet still the objective of this disclosure may be met by productized customer service in the form of computer hardware coupled to a display, a user input device, computer readable memory, and a communication device, wherein said computer readable memory features programming code configured to: control said communication device and display via said computer hardware; receive inputs from said user input device; provide an option to a consumer of a good or service to purchase customer service; collect a fee from the consumer; provide the consumer with a line of communication with a customer service agent whenever said fee is collected; connect the consumer and agent via said line of communication.

### BRIEF DESCRIPTION OF THE FIGURES

The manner in which these objectives and other desirable characteristics can be obtained is better explained in the following description and attached figures in which:

FIG. 1 illustrates a flow diagram of a product for providing first class live interaction with a staff member of a customer service department by charging a fee according to an exemplary embodiment of the present invention;

FIG. 2 illustrates a flow diagram of a method for providing live interaction with a staff member of a customer service department by charging a fee according to an exemplary embodiment of the present invention;

FIG. 3 illustrates a schematic diagram showing different live interaction with the staff member of the customer service department for the method of FIG. 2; and

FIG. 4 illustrates a screenshot of a website showing a tab for purchasing live interaction with the staff member of the customer service according to the method of FIG. 2.

It is to be noted, however, that the appended figures illustrate only typical embodiments disclosed in this application, and therefore, are not to be considered limiting of its scope, for the invention may admit to other equally effective embodiments that will be appreciated by those reasonably skilled in the relevant arts.

### DETAILED DESCRIPTION OF PREFERRED EMBODIMENTS

In general, this disclosure enables productized customer service and related methods of providing customer service. Preferably, a consumer of a good or service (hereinafter “product”) may be provided with an opportunity to purchase customer service or support for the product. Although applicable to any product, in a preferable embodiment, the product may either be provided to the consumer in exchange for a contingent fee or provided for free to the consumer in exchange for revenues (e.g., advertising revenues) derived from a community of consumers. The opportunity may be provided at any time before or after initiation of the consumption of the product and said customer service may be purchased by the consumer on a per use basis (e.g., per customer service request) or by renewable but time-limited subscription (e.g., per month or per year). However accomplished, payment to exercise the option to purchase the customer service or support for the product may preferably enable the user to readily communicate with a live customer service or product support agent. In a suitable embodiment of the disclosure, the customer service is “first class” and may entail high quality customer services where the consumer may ask any questions regarding a specific product and the agent may provide the user with responses to said questions. Any entity (including, but not limited to, businesses, companies, or corporations) may productize customer service or participate in the disclosed methods. The consumer may be any present or future consumer of a product.

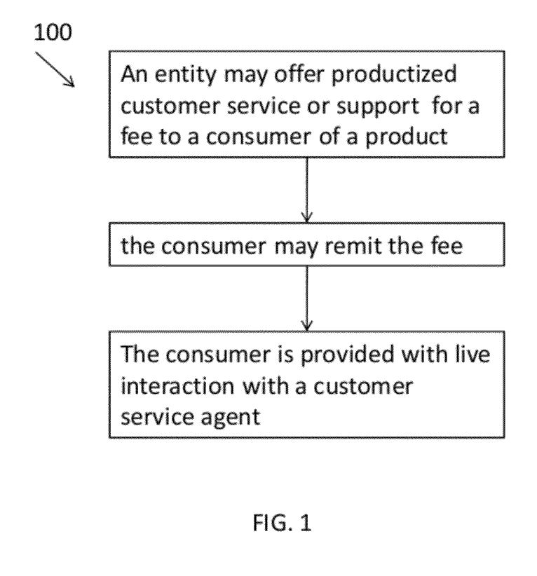

FIG. 1 shows a functional diagram of the productized customer service 100. As seen in the figure, the productized customer service features three main parts: (1) the provision of an offer of customer service for a fee by a product providing entity to a consumer of the product; (2) the exercise of the option by the consumer via payment of said fee; and (3) the accomplishment of the purchased customer service, typically via establishing live interaction between the consumer and a customer service agent.

In the first part, a product providing entity offers customer service to a consumer of the product in exchange for a fee. For example, a consumer of online social networking services may be presented with a command button or other icon indicating that customer service may be purchased with respect to the consumer's social networking account. In the second part, a consumer may exercise the option of customer service via remitting the fee to the entity. Continuing the example above, a consumer of online social networking services may, after clicking (or otherwise interacting with) said command button or other icon, be directed to an electronic payment engine to accomplish electronic funds transfer (e.g., via credit card, Pay Pal®, electronic check, or the like). In the third part, the user is provided with a mechanism for lively interacting with a customer service agent. Still continuing the example, the consumer of online social networking services may be provided with an instant messenger (IM) client and IM contact information for a customer service or support agent so that the consumer and agent may accomplish the customer service via IM “chat.” Although IM chat has been disclosed as a mechanism for the lively interaction of a consumer with a customer service agent, other mechanisms for lively interaction are also suitable. For instance, lively interaction may be accomplished via telephone, electronic mail (email), videophone (e.g., Skype®), or the like.

A preferable embodiment of the productized customer service may be in the form of computer software (or programming code) on computer readable memory coupled to computer hardware and communication hardware. Suitably, the software is configured to display to a user an option to receive customer service for a product in consumption by the user in exchange for a fee. In one non-limiting embodiment, the display may feature a command button or link for exercising the option, wherein user interaction with the command button or link results in a display for accomplishing payment of the fee. In one non-limiting example, the software is configured to present a display for receiving inputs from the user to accomplish electronic funds transfers. Yet still, the software is preferably configured to enable live interaction between the user and a customer service agent so that, after payment of the fee is confirmed, the user may IM chat, videophone, email, or telephone the agent via the communication hardware. Those of skill in the art will know well the manner by which said computer software may be configured to accomplish the offer of customer service, exchange of payment, and live interaction.

Productized customer service may preferably be disclosed by the following examples.

Example 1—Productized customer service for products provided for free to a consumer in exchange for revenues derived from a community of consumers.

The account of a consumer of a social networking client (e.g., Facebook®) may experience technical difficulties. Rather than request services from the communal customer service department or discussion boards, the consumer may be presented with an offer for pay-per-use individualized customer service on a home or settings page of the client. The offer may be represented by a link or icon that directs the consumer to an electronic funds transfer page. The consumer may accept the offer by accomplishing an electronic funds transfer in the amount required by the pay-per-use terms. The consumer may then be directed to live IM interaction with a customer service agent to discuss and resolve the technical difficulty. In some embodiments, the fee may be determined by the time allowed for the live interaction with the staff member of the customer service department. The fee may be a onetime fee, a daily fee, a monthly fee, or a yearly fee.

Broadly, embodiments of the present disclosure generally provide productized customer service and method for providing live interaction with a staff member of a customer service department by charging a user with a fee.

In the present disclosure, the term “first class live interaction” refers to high quality customer services where the user may ask any questions regarding a specific product. The staff member may provide the user with responses to the user specific questions. FIG. 1 shows a functional diagram of a new product 100 for providing first class live interaction with a staff member of a customer service department.

Any licensed business, company or corporation may offer to a user the option for purchasing a first class live interaction with the staff member of the customer service department. The user may be any present customer or future customer.

The user may purchase the productized first class customer service and correspondingly receive from the business, company or corporation, a telephone number. The user may call the phone number to receive a first class live interaction with that company's customer service department.

In order for any business, company or corporation to be able to offer the charging for first class customer service product to a user or customers, the business, company or corporation may purchase a license from the patent owner.

After purchasing the license from the patent owner, the business, company, or corporation may structure pricing and all the details of their new product and service. The business, company or corporation may structure the product or service in any way the suits their business needs for their customers and clients.

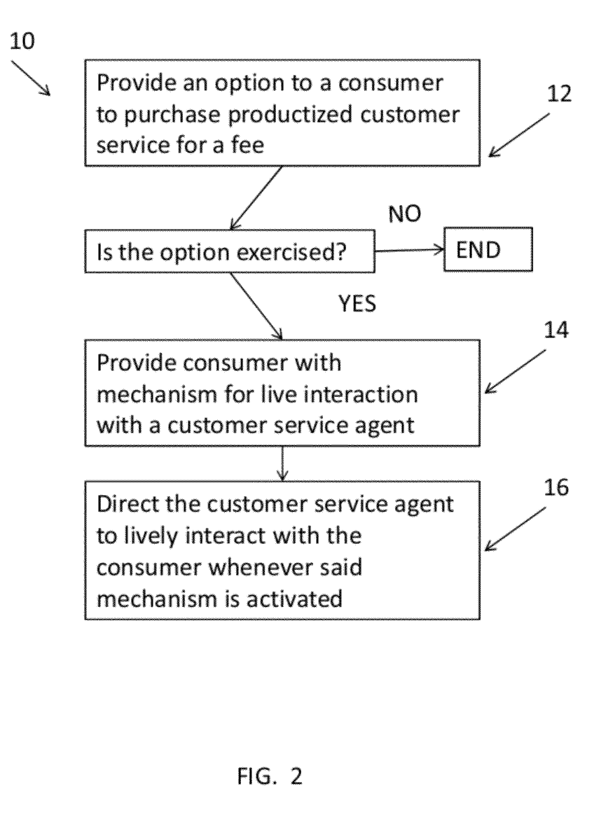

FIG. 2 illustrates a flow diagram of the steps of a method 10 for providing first class live interaction with a staff member of a customer service department by charging a user with a fee. The method 10 may be used by, for example, an existing or new small business, a large corporation, hospitals, clinics, or internet websites. The method 10 may provide the user with the option of purchasing a live interaction with a staff member of the customer service department.

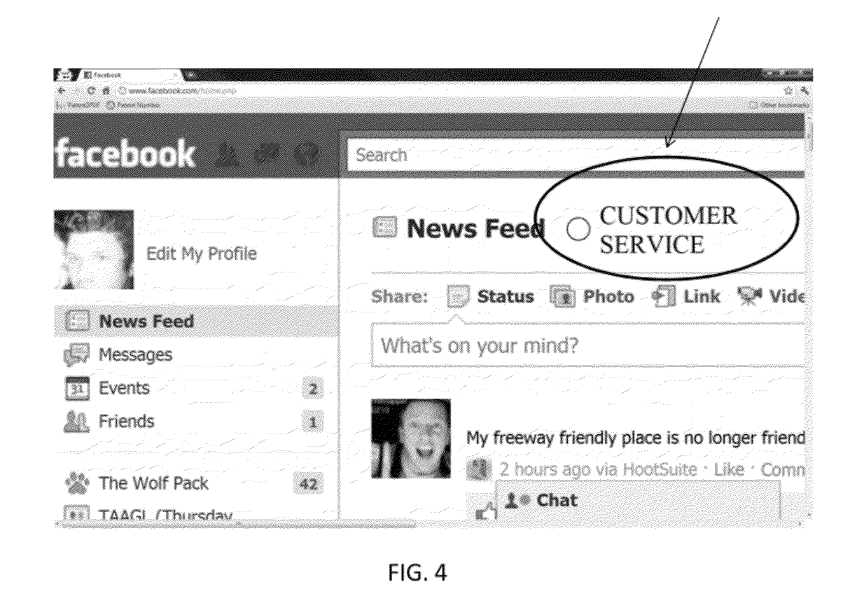

In step 12, a business may create an option for the user to purchase a live interaction with a staff member of the customer service department. FIG. 4 illustrates that the business may create the option by adding a tab 18 into a website 20 related to their business for web users. In addition, the business may create the option by assigning a touch number for telephone users. The creation of the option by the business may be made by a standard process known in the art.

The user may be prompted with the option of purchasing the live interaction with the staff member of the customer service department. Once the user chooses the option, the user may be prompted to pay a fee for the option. The user may choose the option by clicking on the tab 18 or pressing the indicated number. The fee may be established by the business. In some embodiments, the fee may be determined by the time allowed for the live interaction with the staff member of the customer service department. The fee may be a onetime fee, a daily fee, a monthly fee, or a yearly fee.

In step 14, the user may be provided with a special phone number or access code after the payment of the fee. The special phone number or access code may allow the user to directly communicate to the staff member of the customer service department. Each business may have their individual special phone number or access code.

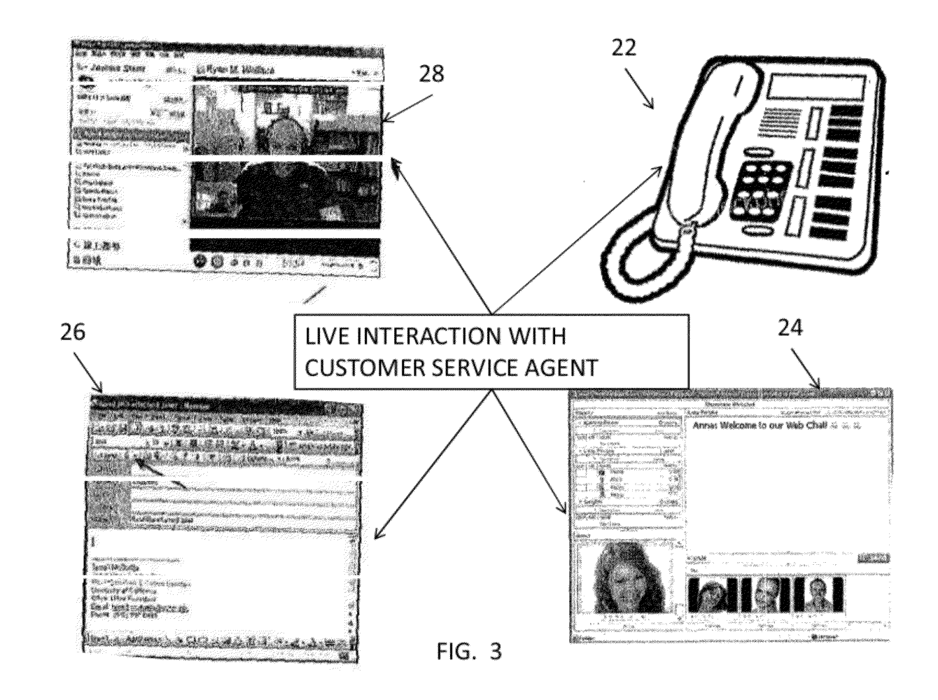

FIG. 3 illustrates that the live interaction may be by telephone 22, chat room 24, e-mail 26, or skype 28. The user may elect the type of interaction.

In step 16, the user may engage in a live conversation with the staff member of the customer service department. The user may ask questions to the staff member of the customer service department. The staff member of the customer service department may provide the user with answers to his/her questions. The method 10 may allow the user to have quality customer service assistance and, at the same time, may create profit for the business.

Moreover, it should be apparent that further numerous structural modifications and adaptations may be resorted to without departing from the scope and fair meaning of the present invention as set forth hereinabove and as described herein below by the claims.

I claim:

1. Software for productized customer service comprising:
programming code on computer readable memory, said programming code configured to
display to a user an option to receive customer service for a product in consumption by the user in exchange for a fee,
receive inputs from the user to accomplish electronic funds transfers, and
enable live interaction between the user and a customer service agent; and,
wherein the product in consumption by the user is provided for free to the user in exchange for revenues derived from a community of consumers of the product.

2. A method of providing customer service comprising the steps of:
Identifying a web based service provided for free;
Offering first class customer service to a consumer of said service for a price;
Receiving remittance of payment in the amount of the price from the consumer; and,
Providing live communication between the consumer and a customer service agent.
